(19) United States
(12) Patent Application Publication
(10) Pub. No.: US 2013/0114526 A1
(43) Pub. Date: May 9, 2013

(54) METHOD FOR PEER DISCOVERY USING DEVICE-TO-DEVICE LINK

(71) Applicant: Electronics and Telecommunications Research In, Daejeon (KR)

(72) Inventors: Jae Young AHN, Daejeon (KR); Choong Il YEH, Daejeon (KR)

(73) Assignee: Electronics and Telecommunications Research Institute, Daejeon (KR)

(21) Appl. No.: 13/652,077

(22) Filed: Oct. 15, 2012

(30) Foreign Application Priority Data
Oct. 14, 2011 (KR) 10-2011-0105563

(51) Int. Cl. H04W 40/24

(52) U.S. Cl. CPC H04W 40/246
USPC 370/329; 370/328

(57) ABSTRACT

A method for discovery using a device-to-device link is disclosed. A method of operating a device includes receiving a request to transmit discovery information, and transmitting or not transmitting the discovery information based on the request. Using the method of operating a device, power consumption of devices and waste of radio resources in a discovery process of direct communication between devices can be reduced, and a problem of resource collision between adjacent devices can be resolved. Further, a problem of adjacent devices assigned to specific frequency resources having a bad channel property not being discovered can be resolved by coping with frequency selectivity.

### CLAIM FOR PRIORITY

This application claims priority to Korean Patent Application No. 10-2011-0105563 filed on Oct. 14, 2011 in the Korean Intellectual Property Office (KIPO), the entire contents of which are hereby incorporated by reference.

### BACKGROUND

1. Technical Field

The present invention relates to a method for discovery using a device-to-device link, and more particularly, to a method of operating a device for peer discovery using a device-to-device link.

2. Related Art

Peer discovery is for devices inside or outside coverage of a mobile communication network to discover presence of ambient peers using a device-to-device link. However, an existing method for discovery between synchronous devices has some problems.

Representative problems include a problem of power consumption and radio resource waste due to periodic transmission of discovery information without condition in a discovery process, a problem of resource collision at the time of transmission of discovery information, and a problem of adjacent devices assigned to a specific frequency resource having a bad channel property not being discovered when SC-FDMA transmission using a single carrier property at the time of transmission of discovery information is adopted.

### SUMMARY

Accordingly, example embodiments of the present invention are provided to substantially obviate one or more problems due to limitations and disadvantages of the related art.

Example embodiments of the present invention provide a method of operating a device in order to resolve a problem of power consumption and radio resource waste due to all devices periodically transmitting their discovery information without condition in a discovery process in discovery using a device-to-device link.

Example embodiments of the present invention also provide a method of operating a device in order to resolve a problem of latency and resource waste due to inevitable execution of a separate procedure for communication between devices for simple information exchange, by enabling the simple information exchange in a discovery process in discovery using a device-to-device link.

Example embodiments of the present invention also provide a method of operating a device in order to resolve a problem of collision of resources for discovery information transmission and a problem of devices assigned to specific frequency resources having a bad channel property continuously not being discovered in a frequency selective channel environment in discovery using a device-to-device link.

In some example embodiments, a method of operating a device in discovery using a device-to-device link includes the steps of: (a) receiving a request to transmit discovery information; and (b) transmitting or not transmitting discovery information based on the request.

Here, when the discovery information is transmitted in step (b), the transmitted discovery information may be received by a device desiring to discover an adjacent device/service.

Here, in step (a), the transmission of the discovery information may be requested from at least one of a user and an application.

Here, in step (a), the transmission of the discovery information may be requested from the other device via the device-to-device link or a base station.

Here, the method of operating a device may further include the step of: (c) requesting the other device to transmit the discovery information via the device-to-device link and receiving the discovery information from the other device based on the request to transmit the discovery information.

In other example embodiments, a method of operating a device in discovery using a device-to-device link includes the step of: transmitting discovery information for discovery to adjacent devices, wherein some bits (a bit sequence) of the discovery information for discovery designate a type of the discovery information.

Here, the bit sequence may specify a group to which the discovery information belongs.

Here, when the bit sequence has a predetermined value, a message to be delivered to an adjacent device may be contained in a part other than the bit sequence in the discovery information.

In still other example embodiments, a method of operating a device in discovery using a device-to-device link includes the steps of: (a) selecting a discovery channel for discovery information transmission; (b) dividing a resource of the discovery channel in each frame into X resource sub-blocks (X is a natural number) and dividing the discovery information into X sub-blocks; (c) transmitting x discovery information sub-blocks (x<=X) among the X resource sub-blocks; and (d) performing reception in X-x resource sub-blocks among the X resource sub-block.

Here, in step (c), the number and the position of resource sub-blocks in which transmission is performed among the X resource sub-blocks may be randomly determined.

Here, a guard period for transmission (reception)/reception (transmission) transition (T/R and R/T transition) may be present between the X resource sub-blocks.

Here, in step (c), reception may be performed in the X-x resource sub-blocks among the X resource sub-blocks, and when a reception level of the resource sub-blocks is equal to or greater than a predetermined threshold, a discovery channel other than the discovery channel selected in step (a) may be reselected to perform steps (b) to (d).

In this case, the predetermined threshold may be in proportion to a prescribed absolute value or a moving average of reception levels of previously received resource sub-blocks.

In still other example embodiments, provided is a method of operating a device in discovery using a device-to-device link, wherein a resource of a discovery channel for discovery information transmission is frequency-hopped and selected.

Here, the resource of the discovery channel may be frequency-hopped in units of to frame periods.

Here, the resource of the discovery channel may be frequency-hopped in units of resource sub-blocks.

Here, the resource of the discovery channel may be frequency-hopped in units of OFDM symbols.

Using the peer discovery method according to the present invention as described above, it is possible to reduce power consumption of the devices and waste of radio resources in the discovery process and resolve the problem of discovery channel collision between adjacent devices.

It is also possible to resolve a problem of adjacent devices assigned to specific frequency resources having a bad channel property not being discovered, by coping with frequency selectivity.

It is also possible to resolve a problem that a separate procedure for communication between devices should be inevitably performed for simple information exchange, by enabling the simple information exchange in the discovery process and to prevent resultant latency and waste of resources.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a concept of direct communication between devices;

FIG. 2 is a frame diagram illustrating a frame structure and a transmission scheme for discovery information transmission according to the present invention;

FIG. 3 is a conceptual diagram illustrating an example of a method of dividing a discovery resource into sub-blocks and determining whether transmission or reception is to be performed in sub-block periods according to the present invention;

FIGS. 4 and 5 are conceptual diagrams illustrating examples in which discovery information is mapped to discovery resource sub-blocks;

FIG. 6 is a conceptual diagram illustrating frequency hopping performed in units of resource sub-blocks within one discovery resource as a scheme of coping with a frequency selective channel according to the present invention; and

FIG. 7 is a conceptual diagram illustrating a case in which both a scheme of coping with a frequency selective channel and a solution to a discovery resource collision problem are applied according to the present invention.

### DESCRIPTION OF EXAMPLE EMBODIMENTS OF THE PRESENT INVENTION

Example embodiments of the present invention are disclosed herein. Specific structural and functional details disclosed herein are merely representative for purposes of describing example embodiments of the present invention.

However, example embodiments of the present invention may be embodied in many alternate forms and should not be construed as limited to example embodiments of the present invention set forth herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” or “device” used herein may refer to a mobile station (MS), user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other terms. Various embodiments of a device may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, and also portable units or terminals having a combination of such functions, but the present invention is not limited thereto.

The term “base station” used herein generally denotes a fixed or mobile point communicating with a device, and may be referred to as a base station, Node-B, evolved Node-B (eNode-B), a base transceiver system (BTS), an access point, a relay, a femtocell, and other terms.

Hereinafter, example embodiments of the present invention will be described in detail with reference to the accompanying drawings. In describing the present invention, the same elements in the drawings will be designated by the same reference numerals in order to facilitate entire understanding and a duplicate description of the same elements will be omitted.

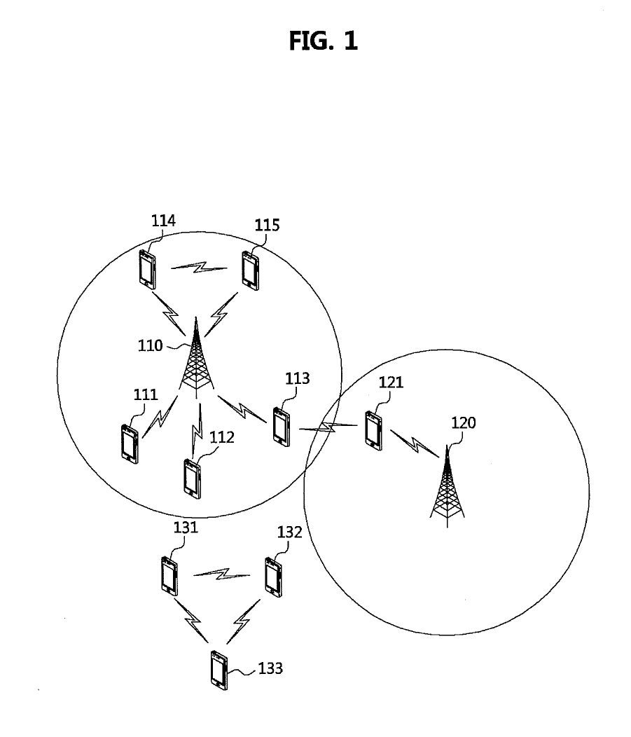

FIG. 1 is a conceptual diagram illustrating a concept of peer discovery using a device-to-device link. Referring to FIG. 1, a cellular communication network including a first base station 110 and a second base station 120 is illustrated.

In this case, first, second and third devices 111, 112, and 113 belonging to a cell created by the first base station are devices that perform normal cellular communication via the first base station, and a fourth device 114 and a fifth device 115 belonging to the first base station are devices that perform direct communication between the devices or/and peer discovery using a direct link therebetween. In this case, the fourth and fifth devices described above may perform the discovery and the communication under control of the base station, or may perform the discovery and the communication with only interaction between the fourth device and the fifth device without being under control of the base station. Further, discovery and communication between the third communication device 113 and the sixth device 121 located in the adjacent cells are possible.

Further, discovery and direct communication between devices present in an environment in which there is no base station, independently from a structure of such a cellular network, are also possible.

For example, a seventh device 131, an eighth device 132, and a ninth device 133 have no base station that serves the respective devices, and the respective devices are independent entities configured to perform discovery and direct communication therebetween.

A representative example of a scheme for peer discovery using a device-to-device link includes a FlashLinQ scheme proposed by Qualcomm. This scheme is a method for discovery between devices of a complete distributed control system in which synchronization between the devices is first established and then each device measures a reception level of each discovery channel using a previously set discovery channel structure and selects a channel whose reception level is lowest to transmit discovery information. Further, all the devices receive all discovery channels and restore information to recognize ambient devices.

When devices do not use the cellular network or are outside the coverage of the cellular network, the respective devices can operate in a distributed control system in which the devices play the same role. For example, each device selects the discovery channel and performs transmission and reception using information of the prescribed discovery channel structure, as in the above-described FlashLinQ. Alternatively, in the above case, a device (a controller) having a central control function may be present or selected and may perform a similar function to that of a base station that will be described below.

When devices are based on a cellular network, discovery between the devices is performed under support of the base station.

In a method for discovery between devices based on a cellular network, a base station broadcasts or individually delivers setting information such as a configuration and a position of resources of a discovery channel in which discovery information can be transmitted and received, and a transmission mode to the respective devices as system information (SI).

Each device may directly select a discovery channel whose reception level is lowest among set discovery channels or may provide measurement information to the base station, request the base station to select the discovery channel, and be assigned a discovery channel from the base station. Using this channel, each device transmits discovery information necessary to inform of the presence of the device (e.g., which is generated using a device ID and an application/service ID).

Further, each device receives the discovery channel using the setting information related to the discovery and recognizes ambient devices.

The method for peer discovery using a device-to-device link according to the present invention is directed to enhancement of an existing method for discovery between devices, and is intended to enhance the following problems associated with an existing method for discovery between synchronous devices.

First, in the existing discovery method, since all devices should periodically transmit the discovery information irrespective of a need/request of the devices or adjacent devices, power consumption increases and radio resources are wasted.

Second, in the existing discovery method, each device transmits only information necessary for its own discovery, and a separate procedure for communication between the devices should be performed to transmit any simple information other than discovery-related information. Accordingly, it is necessary to prepare a method capable of exchange of simple information in a discovery process.

Third, a device desiring to newly transmit the discovery information selects a discovery channel whose reception power is lowest, to avoid the problem of the discovery channel collision between devices.

However, the problem of the collision between devices is not completely resolved by such a method. Further, when the discovery channel is selected once and is continuously used, the collision may not occur at the time of initial selection, but the collision between devices is likely to occur according to movement of devices.

Fourth, when the device transmits continuous sub-carriers using an SC-FDMA scheme in a selected frequency resource for a single carrier property, there is a problem in that adjacent device(s) with a bad channel property of the frequency resource are still not discovered because of frequency selectivity (and because this property differs among device pairs).

Hereinafter, the method for peer discovery using a device-to-device link according to the present invention will be described. The peer discovery method according to the present invention largely includes four schemes: 1) a solution to a problem of increase in power consumption and waste of radio resources due to periodic discovery information transmission, 2) a method of exchanging simple information in a discovery procedure, 3) a solution to a problem of discovery channel collision between adjacent devices, and 4) a scheme of coping with frequency selectivity.

Power consumption and radio resource conserving scheme according to the present invention

In the peer discovery method according to the present invention, an enhancing scheme is a scheme of conserving power consumption and radio resources in a discovery procedure, in which only a device needing to transmit the discovery information transmits the discovery information instead of all devices periodically transmitting the discovery information without condition. Meanwhile, in other discovery periods in which the discovery information transmission is not performed, a reception operation may be performed when discovery of a target device/service is desired.

In a method in which only the device needing to transmit the discovery information transmits the discovery information, a device (or a user or an application) may determine necessity of transmission of the discovery information and transmit the discovery information or may receive a request from an adjacent device and transmit the discovery information.

1) The Device Determines That Transmission of the Discovery Information is Needed and Transmits the Discovery Information

Examples of a case in which the device (or a user or an application) determines that transmission of the discovery information is needed may include a case in which the device desires to be discovered by its peripheral devices, a case in which the device has data desired to be sent, and a case in which the device is in a specific state. In this case, the device may directly select a discovery channel or may select the discovery channel under support of a base station.

In this case, the device may be configured to transmit the discovery information iteratively or during a required period.

2) A Device Receives a Request From an Adjacent Device and Transmits Discovery Information

A device may receive a request to transmit discovery information from an adjacent device. In this case, the other device may directly request the transmission via a device-to-device link or may request the transmission via a base station.

For example, a device that should receive discovery information of adjacent devices for a specific purpose may transmit discovery information reserved in advance for that purpose, and the adjacent devices related to the purpose among the adjacent devices that have received the discovery information may participate in discovery information transmission for a certain time. In this case, if a predetermined time elapses, the device may stop the transmission of the discovery information. Further, according to a type of the discovery information requesting the adjacent devices to transmit the discovery information, all the adjacent devices may perform the transmission or only some devices (conforming to the purpose of the requesting discovery information) may perform the transmission. Meanwhile, in the case of (2), when the device requests the adjacent devices to transmit discovery information, transmission powers of the adjacent devices transmitting the discovery information may vary according to the intent of the request.

When the power consumption and radio resource conserving method described above is used, it is possible to reduce power consumption of the device by not iteratively transmitting the discovery information and it is also possible to conserve radio resources for discovery by reducing the number of used discovery channels.

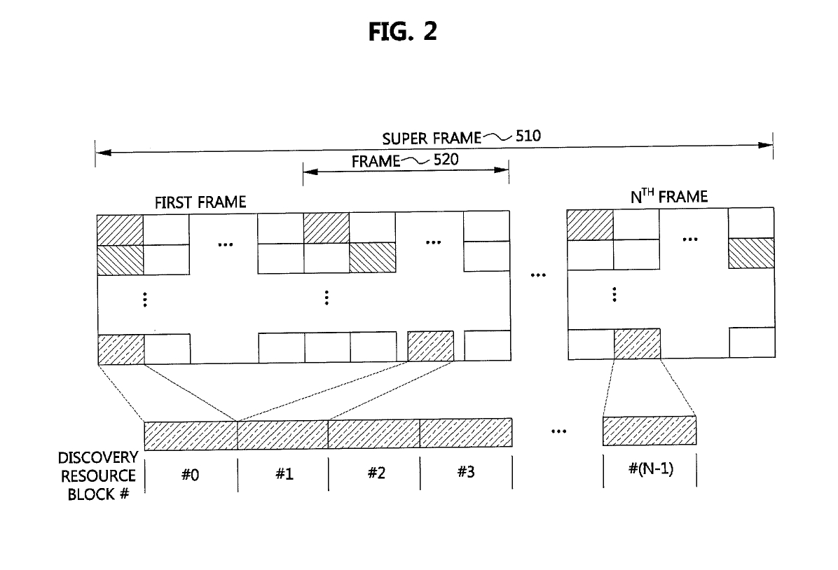

Meanwhile, since reduction of necessary radio resources means that a discovery period (e.g., a super frame period or a frame period that will be described below with reference to FIG. 2) can be reduced. Thus, when the discovery period is reduced, the presence of the adjacent devices can be rapidly recognized.

Scheme for Information Exchange in a Discovery Process According to the Present Invention

If exchange of simple information other than discovery-related information in the discovery process is possible, such information may be utilized for various uses. For this, support of a function that will be described below can enable the simple information to be exchanged in the discovery process.

That is, the discovery information transmitted in the discovery process is constructed for both delivery of general discovery-related information and the exchange of the simple information.

In the general discovery information delivery, a discovery information value corresponding to a specific device/application is assigned via a related server in advance so that the discovery information value is shared by the devices. For the simple information exchange, the discovery information is utilized as a message for information exchange between devices.

For example, in the present invention, a method of assigning a part of the discovery information for discrimination of a general discovery information group and a message group may be applied. In this case, some bits or a bit sequence of the discovery information may be reserved and a value thereof may be used to discriminate content.

In one example, use of one bit of the discovery information is reserved, and when the bit is 0, the bit may indicate the general discovery-related information, and when the bit is 1, the bit may indicate the message. In another example, use of a sequence of two bits of the discovery information is reserved. When a value of the bit sequence is 0, the bit sequence may indicate open discovery information, when the value is 1, the bit sequence may indicate restricted discovery information, when the value is 2, the bit sequence may indicate message group 1, and when the value is 3, the bit sequence may indicate message group 2.

In another example, use of a sequence of 3 bits of the discovery information is reserved. When a value of the bit sequence is 0 to 6, the bit sequence may indicate a group of general discovery information, and when the value is 7, the bit sequence may indicate a message for information exchange.

Solution to a Problem of Discovery Channel Collision According to the Present Invention

A solution to a problem of discovery channel collision according to the present invention is to divide one discovery resource into a number of resource sub-blocks (the number of resource sub-blocks per discovery resource is 1, 2, 3, . . . ) and to monitor whether other device(s) transmit in a resource sub-block period of a device (i.e., whether collision has occurred in the discovery channel) instead of transmitting discovery information of the device in at least one resource sub-block period of time in each frame.

That is, when a signal from the other device is detected in a discovery channel in which a device will transmit discovery information (immediately after the signal is detected once or when the signal is detected several times), the device concedes the discovery channel to the other device, searches for a new unused discovery channel or selects a channel with lowest reception power among discovery channels with low reception power already known through previous reception, and starts transmission.

FIG. 2 is a frame diagram illustrating a frame structure and a transmission scheme for discovery information transmission according to the present invention. In the frame diagram of FIG. 2, only a discovery period of time in a total period of time is conceptually illustrated. A super frame 510 includes a number of frames 520, and each frame may include a number of discovery blocks.

In order to resolve a problem of transmission signals of other adjacent devices that simultaneously transmit discovery information in a discovery information transmission period for discovery between devices of a TDD system not being received and a problem of a low level signal not being received due to a very high reception level from a very adjacent device, a transmission time slot of each discovery channel can be hopped in units of frames. For example, hopping using a Latin square matrix (Latin Square hopping) may be performed.

For example, referring to FIG. 2, the discovery information may be transmitted once for each frame, and the transmission time slot differs from frame to frame. In this case, content (discovery information) of a transmitted block may be the same or different among the frames.

In the present invention, in order to resolve the problem of discovery resource collision between devices, a discovery resource in one frame is divided into X resource sub-blocks (X is a natural number equal to or greater than 1), and reception rather than transmission is performed in some resource sub-blocks to monitor whether an adjacent device is using the same discovery channel as the device.

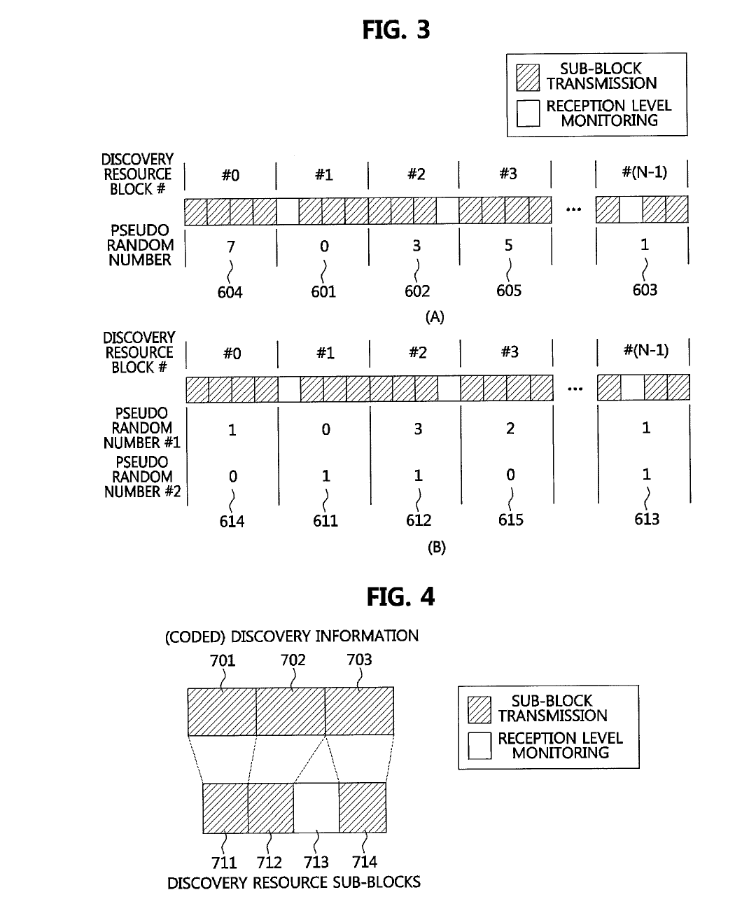

FIG. 3 is a conceptual diagram illustrating an example of a method of dividing a discovery resource in each frame into sub-blocks and determining whether transmission or reception is to be performed in each sub-block period according to the present invention.

Referring to FIG. 3, a discovery resource in one frame is divided into X (X is a natural number equal to or greater than 1) resource sub-blocks, as described above. In this case, by producing a pseudo random sequence(s) for each discovery channel, a determination may be made as to whether discovery information is transmitted using all the resource sub-blocks in each frame or using some of the resource sub-blocks and how a resource sub-block in which the discovery information is not transmitted is selected.

Referring to FIG. 3(a), an example embodiment is illustrated in which a value belonging to {0, 1, 2, . . . , X-1, . . . , M-1} (M>=X) may be randomly generated. When the random value for a frame is equal to or less than (X-1) (see 601, 602 and 603), a discovery information sub-block may not be transmitted but a reception level may be monitored in the resource sub-blocks corresponding to the value among the X resource sub-blocks.

Referring to FIG. 3(a), each discovery resource in one frame is divided into four resource sub-blocks. When the random value for the frame is 0 to 3, the discovery information sub-block is not transmitted in the resource sub-block corresponding to the value, and when the random value is 4 or more, the discovery information is transmitted in all the resource sub-blocks. For example, when the random value is 0, the discovery information is not transmitted in a first resource sub-block period. When the random value is 3, the discovery information is not transmitted in a fourth resource sub-block period. When the generated value is X or more (see 604 and 605), the discovery information may be transmitted in all the resource sub-block periods. Referring to FIG. 3(b), another example embodiment is illustrated in which a pseudo random sequence #1 whose random value is one of 0, 1, 2, . . . , X-1 may be generated and a binary random sequence #2 may be additionally generated. A determination may be made as to whether the discovery information will be transmitted in all resource sub-block periods in a frame transmission or only in some resource sub-block periods based on the binary random sequence. A resource sub-block period in which a reception level will be monitored instead of the discovery information being transmitted may be determined based on the value belonging 0, 1, 2, . . . , X-1.

That is, when the binary random value is 1 (or 0) (see 611, 612, and 613), the reception level may be monitored instead of the discovery information being transmitted in the resource sub-block period corresponding to the random value belonging to {0, 1, 2, . . . , X-1}, and when the binary random value is 0 (or 1) (see 614 and 615), the discovery information may be transmitted in all the resource sub-blocks.

A base M random sequence whose random value is one of 0, 1, 2, . . . , M-1 rather than binary random may be used as random sequence #2. In this case, for example, when the random value is not (M-1), the discovery information may be transmitted in all the resource sub-blocks.

Meanwhile, a guard period for transition between transmission (reception) and reception (transmission), that is, for T/R or R/T transition, may or may not be present between the resource sub-block periods. If a separate guard period is not prepared, it may be necessary to perform the T/R and R/T transition within the resource sub-block period. SC-FDMA (DFT-s-OFDM) or OFDMA may be used as a scheme of transmitting the discovery information. As a modulation and demodulation scheme, non-coherent demodulation such as on-off-keying (00K) may be applied or coherent demodulation may be applied.

If the coherent demodulation is applied, it is necessary to design a pilot (RS: Reference Signal) so that demodulation is possible even when one of adjacent resource sub-blocks is not received. It is understood that RS may be unnecessary for energy detection for monitoring a reception level.

In relation to FEC channel coding for discovery information transmission, there are a scheme in which FEC channel coding is not performed and a scheme of selectively applying one of various types of FEC channel coding. In this case, when FEC channel coding is applied, CRC may or may not be used.

Meanwhile, when X>1, since a discovery resource in one frame is divided into a plurality of resource sub-block periods and the discovery information is not transmitted in some of the resource sub-blocks, it is necessary to determine how the discovery information that should be transmitted in the discovery channel periods is divided and mapped to the resource sub-blocks.

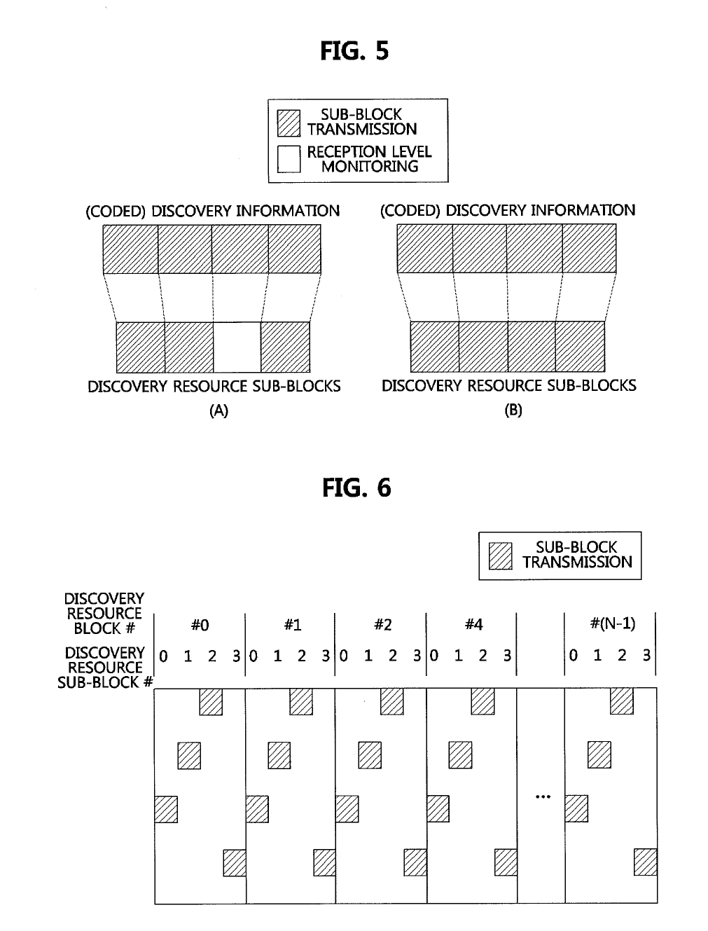

FIGS. 4 and 5 are conceptual diagrams illustrating examples in which the discovery information is mapped to discovery resource sub-blocks in one frame.

Referring to FIG. 4, an example embodiment is illustrated in which the discovery information may be divided into discovery information sub-blocks less than the resource sub-blocks in one frame and mapped. For example, a case in which the discovery information is divided into three discovery information sub-blocks 701, 702 and 703 and the discovery resource is divided into four resource sub-blocks 711, 712, 713, and 714 is illustrated in FIG. 4. This means that the discovery information sub-block is not mapped to one resource sub-block 713 in the entire discovery channel period.

Referring to FIG. 5, another example embodiment is illustrated in which the discovery information may be divided to be equal in number to sub-blocks of a discovery resource in one frame. In this case, (a) the discovery information sub-block may not be transmitted in at least one of the resource sub-blocks, and (b) the discovery information sub-blocks may be transmitted in all the resource sub-blocks, as in the above-described example in which the pseudo random sequence generation is used.

In this case, in the case of (a), i.e., when one of the discovery information sub-blocks is not transmitted, a receiving side recognizes that the sub-block is punctured and transmitted. Accordingly, the receiving side may perform channel decoding in consideration of that fact.

Meanwhile, operation of a discovery information transmission device will be described.

When the discovery information sub-blocks are not transmitted in some resource sub-blocks using a method such as the random value generation described above, the device monitors a reception level in such resource sub-block periods.

When the device determines that the other adjacent device transmits discovery information using the same discovery resource as a result of monitoring the discovery resource used for transmission of the discovery information, the device may concede the resource to the other adjacent device, newly search for other unused resources or select the discovery channel with the lowest reception power among low reception level discovery channels recognized through previous reception, and transmit discovery information.

In this case, 1) a method of performing a fast Fourier transform (FFT) on an entire band and then measuring a reception level for a frequency band of the discovery channel (for this, reception of one or more whole OFDM symbols is required) or 2) a method of filtering only a frequency band including the discovery channel using a band pass filter and measuring a reception level (in this case, there is an advantage in that processing latency can be reduced as compared to the method (1)) may be applied as a method of monitoring a reception level instead of transmitting the discovery information in the sub-block period.

When a reception level in a resource sub-block of a device in which reception rather than discovery information transmission is performed is equal to or higher than a threshold, the other adjacent device is determined to transmit the discovery information using the same discovery channel.

In this case, a predefined absolute value may be used as the reception level threshold for determination as to whether the discovery channel has been occupied by the other adjacent device. Alternatively, a variable threshold obtained by taking a moving average of reception levels in some previous sub-blocks in which the reception rather than the transmission has been performed may be used instead of the absolute value. This is intended to consider variation of the reception level due to influence of interference or noise.

In this case, when the moving average is taken, additional manipulation such as weighting of a recent value may be made. Further, a reception level of the discovery channel when a discovery channel for transmission is determined (when it is determined that the discovery channel is not used or has the lowest congestion) may be used as an initial value of the threshold.

Further, an operation of a discovery information reception device will be described.

The reception device may be configured to receive all or some discovery channels of a relevant time after performing an FFT.

In this case, when the discovery information is divided into fewer discovery information sub-blocks than the resource sub-blocks and then transmitted as described above, the receiving device can recognize which sub-block of the discovery channel is for discovery information transmission and accordingly can decode the discovery information.

In this case, when the discovery information is divided into as many discovery information sub-blocks as the resource sub-blocks and then transmitted as described above, there may be a case in which FEC coding has been applied and a case in which FEC coding has not been applied.

When FEC coding has not been applied, one discovery information sub-block of the discovery information may not be transmitted. Accordingly, in this case, the reception device waits until a next block is received. That is, when each block is received, all blocks may be combined using the sub-block of a previous block or a current block and used to restore the discovery information, instead of receiving resource sub-blocks that have not been transmitted among resource sub-blocks.

When FEC coding has been applied, one sub-block of the block may not be transmitted, but in this case, a receiving side can recognize that the sub-block is punctured and transmitted. Accordingly, the receiving side can perform decoding in consideration of that fact, and the discovery information can be restored according to a code rate of FEC coding or a state of a link. Further, sub-blocks received in a current frame and sub-blocks of the discovery channel received in a previous or next frame may be combined to decode the discovery information.

When the method of dividing discovery resources according to the present invention is used, the Latin square hopping described above may be unnecessary. If the guard period for T/R or R/T transition is present between the sub-blocks or if a time for transmission/reception and reception/transmission transition is separately unnecessary when sub-blocks are transmitted in a time-distributive manner and received in a transmission period, Latin square hopping performed in each frame may be unnecessary. That is, if an FFT is performed to receive signals for all other discovery channels in the period of time and combine the signals over several frames when a device performs reception in its own transmission period, all signals for the respective discovery channels can be received when reception in all sub-block transmission periods is completed, and accordingly Latin Square hopping may be unnecessary. In this case, it will be unnecessary to define the super frame.

Scheme of Coping With a Frequency Selective Channel According to the Present Invention

A scheme of coping with a frequency selective channel according to the present invention is a scheme of coping with a case in which a transmission scheme in which discovery information should be transmitted with continuous sub-carriers in order to maintain a single carrier property of SC-FDMA (DFT-s-OFDM) is applied as the scheme of transmitting discovery information.

In this case, examples of the scheme for coping with a frequency selective channel may include a scheme of abandoning the single carrier property and transmitting the discovery information using sub-carriers distributed in a frequency domain, and a scheme of performing frequency hopping while maintaining the single carrier property. The scheme of performing frequency hopping while maintaining the single carrier property will be described herein.

Examples of the scheme of performing frequency hopping while maintaining the single carrier property may include (1) a scheme of applying frequency hopping in units of frames (in this case, a device that has not performed reception well in a previous frame can perform the reception well in a next frame), (2) a scheme of applying frequency hopping in units of OFDM symbols, and (3) a scheme of applying frequency hopping in units of sub-blocks.

In the case of the schemes (2) and (3), frequency diversity can be obtained even within one discovery channel period and different hopping patterns can be applied to each frame.

FIG. 6 is a conceptual diagram illustrating frequency hopping in units of sub-blocks within one discovery resource as the scheme of coping with a frequency selective channel according to the present invention.

Referring to FIG. 6, a pattern in which sub-blocks are frequency-hopped in each of discovery channel blocks (blocks #0, #1, #2, . . . , #(N-1)) is illustrated.

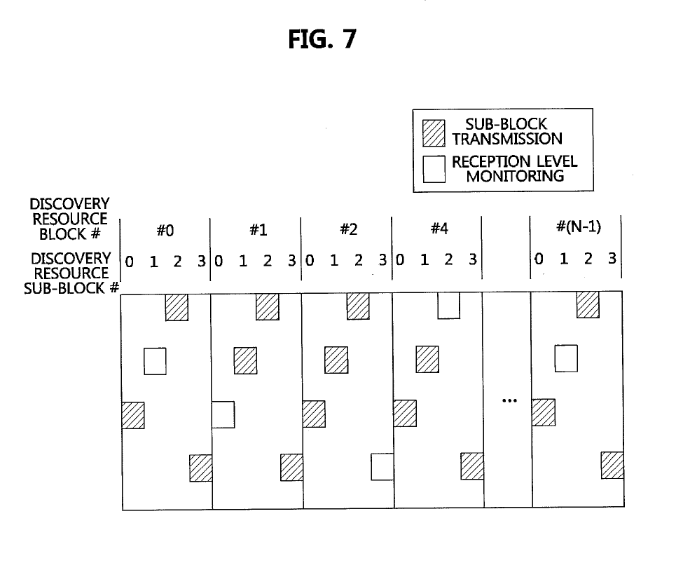

Frequency hopping in units of OFDM symbols may be similarly operated. FIG. 7 is a conceptual diagram illustrating a case in which both the scheme of coping with a frequency selective channel and the solution to a discovery resource collision problem according to the present invention are applied.

Referring to FIG. 7, an example of a transmission pattern when both frequency hopping in units of resource sub-blocks illustrated in FIG. 6 and a solution to a problem of collision of discovery resources between adjacent devices are applied is described.

Similarly, frequency hopping in units of OFDM symbols may be similarly operated. While the example embodiments of the present invention and their advantages have been described in detail, it should be understood that various changes, substitutions and alterations may be made herein without departing from the scope of the invention.

What is claimed is:

1. A method of operating a device in discovery using a device-to-device link, the method comprising the steps of:
(a) receiving a request to transmit discovery information; and
(b) transmitting or not transmitting discovery information based on the request.

2. The method of claim 1, wherein, when the discovery information is transmitted in step (b), the transmitted discovery information is received by a device desiring to discover an adjacent device/service.

3. The method of claim 1, wherein, in step (a), the transmission of the discovery information is requested from at least one of a user and an application.

4. The method of claim 1, wherein, in step (a), the transmission of the discovery information is requested from another device via the device-to-device link or a base station.

5. The method of claim 1, further comprising the step of:
(c) requesting another device to transmit the discovery information via the device-to-device link and receiving the discovery information from the other device based on the request to transmit the discovery information.

6. A method of operating a device in discovery using a device-to-device link, the method comprising the step of:
transmitting discovery information for discovery to adjacent devices,
wherein some bits (a bit sequence) of the discovery information for discovery designate a type of the discovery information.

7. The method of claim 6, wherein the bit sequence specifies a group to which the discovery information belongs.

8. The method of claim 6, wherein, when the bit sequence has a predetermined value, a message to be delivered to an adjacent device is contained in a part other than the bit sequence in the discovery information.

9. A method of operating a device in discovery using a device-to-device link, the method comprising the steps of:
(a) selecting a discovery channel for discovery information transmission;
(b) dividing a resource of the discovery channel in each frame into X resource sub-blocks (X is a natural number) and dividing the discovery information into X sub-blocks;
(c) transmitting x discovery information sub-blocks (x<=X) among the X resource sub-blocks; and
(d) performing reception in X-x resource sub-blocks among the X resource sub-blocks.

10. The method according to claim 9, wherein, in step (c), the number and the position of resource sub-blocks in which transmission is performed among the X resource sub-blocks are randomly determined.

11. The method according to claim 9, wherein a guard period for transmission (reception)/reception (transmission) transition (T/R and R/T transition) is present between the X resource sub-blocks.

12. The method according to claim 9, wherein, in step (c), reception is performed in the X-x resource sub-blocks among the X resource sub-blocks, and when a reception level of the resource sub-blocks is equal to or greater than a predetermined threshold, a discovery channel other than the discovery channel selected in step (a) is reselected to perform steps (b) to (d).

13. The method according to claim 12, wherein the predetermined threshold is based on a prescribed absolute value or a moving average of reception levels of previously received resource sub-blocks.

14. A method of operating a device in discovery using a device-to-device link, wherein a resource of a discovery channel for discovery information transmission is frequency-hopped and selected.

15. The method according to claim 14, wherein the resource of the discovery channel is frequency-hopped in units of frame periods.

16. The method according to claim 14, wherein the resource of the discovery channel is frequency-hopped in units of resource sub-blocks.

17. The method according to claim 14, wherein the resource of the discovery channel is frequency-hopped in units of OFDM symbols.
